(19) United States
(12) Patent Application Publication
(10) Pub. No.: US 2014/0370615 A1
(43) Pub. Date: Dec. 18, 2014

(54) USE OF OPTICALLY ANISOTROPIC PARTICLES

(71) Applicant: Leibniz-Institut fuer neue Materialien gemeinnuet- zige Gesellschaft mit beschraenkter Haftung, Saarbruecken (DE)

(72) Inventors: Tobias Kraus, Saarbruecken (DE); Si Chen, Toronto (CA)

(73) Assignees: Leibniz-Institut fuer neue Materialien gemeinnuetzige Gesellschaft mit; beschraenkter Haftung, Saarbruecken (DE)

(21) Appl. No.: 14/363,124

(22) PCT Filed: Dec. 7, 2012
(86) PCT No.: PCT/DE2012/100373

§ 371 Date: Jun. 5, 2014

(30) Foreign Application Priority Data
Dec. 22, 2011 (DE) 10 2011 056 898.0

(51) Int. Cl. G01N 21/88

(52) U.S. Cl. CPC G01N 21/88
USPC 436/164

(57) ABSTRACT

This invention relates to the use of optically anisotropic particles in order to non-destructively test or determine physical system parameters and/or the microscopic structure of systems. The mobility of the optically anisotropic particles is used to examine physical system parameters and/or the microscopic structure of systems. To this end, particle mobility is measured via an optical system.

This invention relates to the use of optically anisotropic particles.

Physical system parameters are of importance in numerous fields. In the fields of biology, protein crystallography, nanotechnology, chemistry, mechanical engineering and material sciences, for example, it is important to determine physical parameters such as the state of aggregation, and thus also the curing or softening states, of soft materials, for example gels, polymer solutions, complex media or adhesives. The microcrospic structure of a system, too, may be deduced from its physical parameters.

This is explained in more detail below, using adhesives as an example.

Adhesives are especially interesting because adhesive joints are increasingly replacing welded, riveted, threaded or soldered joints in modern motor-vehicle, aircraft and train construction.

The use of adhesive joints has familiar advantages over the use of conventional joining techniques. Compared with soldering or welding, it is relatively easy to produce large-area joints. An additional advantage of a suitably configured adhesive joint is that it distributes stresses and transmits load evenly over the entire bonded area. This joint is effective under static and dynamic loading. In the case of threaded and riveted joints, by contrast, stress is concentrated at the jointing elements while the space therebetween transmits hardly any load.

A further known advantage of adhesive bonding is that neither the surface nor the microscopic structure are changed. The temperatures involved in welding can cause changes in the microscopic structure and mechanical properties of materials. In the case of riveted and threaded connections, the visible surface is altered. With bonding, the surface remains unchanged, making for optimal aerodynamic and optical properties. By virtue of the fact that the adhesive is flexible and covers the entire joint area, the vibration damping property of a glueline is better than that of welded, threaded or riveted joints.

Another benefit of adhesive bonding is that a saving in weight is often achieved. This is why adhesives are particularly favoured in light-weight construction, where they enable thin components to be joined together. This would be problematic, if not impossible, with thermal jointing techniques.

Yet another advantage of adhesives is that they serve simultaneously as a seal for gases and liquids. The adhesive layer prevents the ingress of condensation water and subsequent corrosion. Particularly in the motor-vehicle, aircraft and train-construction industries, adhesives are useful for joining dissimilar materials (glass-metal, wood-metal, aluminium-steel) that cannot be joined by thermal techniques. Thanks to the electrical and thermal insulation (normally) provided by the adhesive, the formation of local elements and associated contact corrosion in metals is prevented. Damage to the workpieces to be joined can be avoided through use of adhesives since an adhesive joint involves no changes to the workpieces and can, in many cases, be undone again without damaging them.

An additional benefit is that workpieces to be joined often need not be heated, thereby precluding any thermal distortion or stresses in the bonded assembly. Furthermore, selection of a suitable adhesive can have a major influence on the component's mechanical properties.

A disadvantage of adhesives, however, is that aging (caused by mechanical, chemical, physical and biological influences) and temperatures above or below given limits (low temperatures causing embrittlement, high temperatures initially causing softening and then, as the temperature rises further, causing non-cross-linked polymers to melt and cross-linked polymers to degrade) may cause changes in the system.

This is potentially dangerous, as uses of adhesives nowadays include window construction, fitting of windscreens, spoilers, external decorative trim and the steering column in motor vehicles, bonding of aeroplane wing units and bonding of bridges, crowns, veneers and inlays in dental medicine.

Another disadvantage of these systems, each of which has different physico-chemical properties, is the absence of any non-destructive methods of testing strength or deformability, for example. The only way of testing these properties is by means of destructive tests performed on reference samples (test specimens) manufactured under identical conditions.

Standardised test methods and test speciment have been developed for this purpose and enable different systems to be compared. However, since the properties of adhesives depend not only on the system itself but, for instance, are strongly affected by other factors, too, such as adherends, the material these are made of their surface condition and their geometry, test specimens are ideally made of the same materials as are used in the application. Since the conditions under which the systems are used also vary from application to application, separate tests must be performed under each set of conditions. The various tests are accordingly performed under the defined conditions, or the test specimen is conditioned in a defined climate prior to being tested.

The object of this invention is therefore to non-destructively test and/or determine physical system parameters.

This object is established according to the invention by using optically anisotropic particles to investigate physical system parameters, the mobility of the particles being measured via an optical system.

Use of the optical system is advantageous because it enables particle mobility in the system under test to be measured non-destructively.

Claim 2 provides for the physical parameters to be mechanical, as, in particular, curing and/or softening states, thermal or electrical system properties.

Physical system parameters such as curing and/or softening states can be determined by measuring particle mobility via an optical system.

With regard to the optical system, it is conceivable that a dynamic light scattering (DLS) measurement be performed, followed by computer evaluation of the recorded signal. Use of the optical system is advantageous because it enables non-destructive measurement not only of particle mobility but also of heterogeneity in the system under test.

Since sufficiently optically anisotropic oxide particles, for example titanium dioxide or zirconium dioxide, are used as fillers in systems such as polymers or adhesives, the time-related curing and/or softening state of these systems can be monitored and documented via optical measurement.

According to claim 3, an embodiment of the invention provides for the optically anisotropic particles to be metallic nanorods, which are added to the system under test.

As not all systems contain optically anisotropic particles, it would be possible to add optically anisotropic metallic nanorods to the system during its production process. It would then be possible to monitor and document the time-related curing and/or softening state of these systems via optical measurement.

To this end, provision is made for the body of the metallic nanorods to be cylindrical or polygonal.

The use of metallic nanorods as optically anisotropic particles and their measurement via an optical system also permits determination of a system's heterogeneity. For example, it would be possible to determine the heterogeneity via an optical measurement at various test points/areas, since the use of optically anisotropic nanorods makes it possible to establish whether the metallic nanorods are still able to move at one of the selected test points/areas but no longer at another. Nanorods with a cylindrical body generate a less complex signal than nanorods with a polygonal body, but this does not rule out use of the latter.

It is envisaged according to claim 4 that the metallic nanorods consist of, or are coated with, gold, silver, copper, nickel, zinc, platinum or metal oxides, more particularly zirconium dioxide, titanium dioxide, silicon dioxide, zinc oxide or aluminium oxide.

Particles of the metals described above are anisotropic and are efficient polarisers. In this connection, it is furthermore conceivable that metal oxides be on hand in doped or non-doped form.

It is envisioned according to claim 5 that, for purposes of using optically anisotropic particles to investigate curing and/or softening states of systems, the concentration of metallic nanorods in the system be less than or equal to 10¹⁴ m⁻³ and the resulting metal concentration less than 10⁻⁵ mol/l.

With such a low concentration of metal added to the system, the use of optically anisotropic metal nanorods for determining physical system parameters is cost-effective.

According to claim 6, furthermore, provision is made for the metal nanorods to exhibit surface plasmons.

According to claim 7, it is conceivable that the metallic nanorods be configured with a core made of a polymer or glass.

The metallic particles could then be bound to the polymer or glass via incorporation of functional chemical groups, for example cyano groups (CN), amino groups (NH₂) or thiol groups (SH). This form of production would reduce the cost of the metals, some of them precious.

According to claim 8, furthermore, the metallic nanorods are conceivably surface-modified.

In this context, it is possible for the metallic nanorods to be modified in such a manner that they interact specifically with components of a system (e.g. a polymer system) or are incorporated in the system. It is also to advantage here if the metallic nanorods are only partially surface-modified, thereby permitting additional, possibly more detailed, information to be obtained about the system under test.

It is furthermore expedient to use the surface-modified metallic nanorods as chemical sensors. This could be achieved, for example, by embedding the metallic nanorods in a solid material in which, however, the metallic nanorods are still able to move. In the event that the metallic nanorods adsorb specifically or non-specifically onto larger molecules, the particle mobility of the nanorod/molecule combination would sink. It would be possible to measure this change via an optical system. Since metallic nanorods are also more stable than ordinary chemical sensors based on particles in dispersions, it is furthermore conceivable to integrate the metallic nanorods in packaging, for example, and to determine and document the service life or level of deterioration of this packaging.

The greater the aspect ratio of the nanorods is, the easier it is to determine the particle mobility of the nanorods via dynamic light scattering measurement. If the aspect ratio increases, so does the depolarised share of the scattered light. Since the non-polarised share of the light is filtered out prior to measurement, the signal is stronger, the necessary integration time, and hence the measurement time, shorter and the signal/noise ratio (and therefore the measuring quality) higher.

Claim 9 therefore provides for the metallic nanorods to have an aspect ratio greater than 2.5.

According to claim 10, provision is made for the particles to have a sphericity of less than 0.9 and for their surfaces to have edges and/or corners with a radius of less than 20 nm.

The sphericity Ψ of a body K is the ratio of the surface area of a ball of equal volume to the surface area of the body:

$$Ψ = \frac{{{π}^{\frac{1}{3}} ( {V}_{p} )}^{\frac{2}{3}}}{{A}_{p}}$$

where Vₚ is the volume of the body and Aₚ its surface area.

Certain aspects of the material under test can be analysed via the geometry and dimensions of the nanorods. If, for example, the nanorods are very small, they are blocked in position later than large nanorods. The use of nanorods of varying dimensions at different points in time is thus by all means worth considering in order to determine the physical parameters and/or microscopic structure of the system under test.

For the investigation of physical system parameters, it is advantageous according to claim 11 if the system is an organic or an inorganic system.

According to claim 12, it is also to advantage if the system is an organic system in which the state of aggegation is dependent on temperature and pressure.

Soft materials, in particular, are of interest in the fields of biology, protein crystallography, nanotechnology, chemistry, structural engineering, materials science and for joining.

Claim 13 accordingly provides for the organic system to be a soft material, which is cross-linked.

Familiar and frequently used soft materials of this kind include, by way of example, gels, polymer solutions and complex media. The state of aggregation of soft material often depends on temperature and pressure, as a result of which the material may take the form of a gas, liquid, structured soft material or hybrid material, or be in the hardened state.

Gels are frequently used in biology for electrophoresis as they form a closely cross-linked network that hinders the molecules to be separated from migrating withing the electrical field. Familiar gels used in analytics include, for example, agarose gels and polyacrylamide gels.

Polymers include, for example, polyethylene, polypropylene or polyamide, polyester, polymethylmethacrylate (PMMA), polyethylene terephthalate (PET), polytetrafluoroäthylen (PTFE), polyurethanes, polystyrene (PS) and polyvinyl chloride. However, biopolymers, too (DNA, RNA, proteins, cellulose, chitin, starch, polyhydroxyalkanoate, . . . ) or chemically modified polymers such as nitrocellulose, celluloid or starch derivatives are also used and measured in many areas of nanotechnology, chemistry, materials science and for joining.

1. Use of optically anisotropic particles to investigate physical system parameters, particle mobility being measured via an optical system.

2. Use according to claim 1, wherein the physical parameters are mechanical, as, in particular, curing and/or softening states, thermal or electrical system properties.

3. Use according to claim 1, wherein the optically anisotropic particles are metallic nanorods, which are added to the system under ₜest.

4. Use according to claim 3, that wherein the metallic nanorods consist of, or are coated with, gold, silver, copper, nickel, zinc, platinum or metal oxides, more particularly zirconium dioxide, titanium dioxide, silicon dioxide, zinc oxide or aluminum oxide.

5. Use according to claim 3, wherein the concentration of metallic nanorods in the system is less than or equal to 10¹⁴ m⁻³ and the resulting metal concentration less than 10⁻⁵ mol/l.

6. Use according to claim 3, wherein the metal nanorods exhibit surface plasmons.

7. Use according to claim 3, wherein the metallic rods have a core made of a polymer or glass.

8. Use according to claim 3, wherein the metallic nanorods are suface-modified.

9. Use according to claim 3, wherein the metallic nanorods have an aspect ratio greater than 2.5.

10. Use according to claim 1, wherein the particles have a sphericity of less than 0.9 and their surfaces have edges and/or corners with a radius of less than 20 nm.

11. Use according to claim 10, wherein the system is an organic or an inorganic system.

12. Use according to claim 11, wherein the system is an organic system in which the state of aggregation is dependent on temperature and pressure.

13. Use according to claim 12, wherein the organic system is a soft material, which is cross-linked.
